(19) United States
(12) Patent Application Publication
(10) Pub. No.: US 2023/0047611 A1
(43) Pub. Date: Feb. 16, 2023

(54) METHOD FOR DISPLAYING SEARCH CONTENTS AND ELECTRONIC DEVICE

(71) Applicant: BEIJING DAJIA INTERNET INFORMATION TECHNOLOGY CO., LTD., Beijing (CN)

(72) Inventors: Yiren Li, Beijing (CN); Yongsheng Ma, Beijing (CN)

(21) Appl. No.: 17/973,721

(22) Filed: Oct. 26, 2022

Related U.S. Application Data
(63) Continuation of application No. PCT/CN2020/128788, filed on Nov. 13, 2020.

(30) Foreign Application Priority Data
Jun. 29, 2020 (CN) 202010610098.8

(51) Int. Cl. G06F 16/9538; G06F 16/9535

(52) U.S. Cl. CPC G06F 16/9538; G06F 16/9535

(57) ABSTRACT

A method for displaying search contents and an electronic device. The method includes: receiving a search keyword input by a user, recognizing and acquiring a display intention type corresponding to the search keyword; determining a search content display template corresponding to the display intention type; and displaying search result contents corresponding to the search keyword based on the search content display template. The display intention type includes a convergent display intention, and the content viewing mode of the user corresponding to the convergent display intention is searching for and viewing a specific content; or the display intention type includes a divergent display intention, and the content viewing mode of the user corresponding to the divergent display intention is searching for a class of contents and viewing searched contents one by one.

### CROSS-REFERENCE TO RELATED APPLICATION

The application is a continuation application of International Application No. PCT/CN2020/128788, filed on Nov. 13, 2020, which claims the priority to Chinese Patent Application No. 202010610098. 8, filed on Jun. 29, 2020, all the contents of which are incorporated herein by reference for all purposes.

### TECHNICAL FIELD

The disclosure relates to a Internet technology, and particularly to a method and an apparatus for displaying search contents, an electronic device and a storage medium.

### BACKGROUND

A search engine is a common information search tool, and a user can search for required information through a search engine.

Taking a short video content platform as an example, a user inputs a search keyword, and a content platform server determines search contents such as short videos conforming to the search keyword, and sends the search contents to a client for display. In the related art, a display style of search contents is usually fixed, and cannot satisfy the personalized requirement of a user for content browsing.

### SUMMARY

According to a first aspect of embodiments of the disclosure, a method for displaying search contents is provided, including: receiving a search keyword input by a user, recognizing and acquiring a display intention type corresponding to the search keyword; determining a search content display template corresponding to the display intention type; and displaying search result contents corresponding to the search keyword based on the search content display template. The display intention type is corresponding to a content viewing mode of the user a search result, and the content viewing mode is a preferred viewing mode of the user on the search result in a current search. The display intention type includes a convergent display intention, and the content viewing mode of the user corresponding to the convergent display intention is searching for and viewing a specific content; or the display intention type includes a divergent display intention, and the content viewing mode of the user corresponding to the divergent display intention is searching for a class of contents and viewing searched contents one by one.

According to a second aspect of embodiments of the disclosure, a server is provided. The server includes a processor and a memory configured to store instructions executable by the processor. The processor is configured to execute the instructions to implement: receiving a search keyword uploaded by a client, recognizing and acquiring a display intention type corresponding to the search keyword; acquiring search result contents corresponding to the search keyword and filling the search result contents into the content display template; and sending the content display template filled with the search result contents to the client for display. The display intention type is corresponding to a content viewing mode of the user a search result, and the content viewing mode is a preferred viewing mode of the user on the search result in a current search. The display intention type includes a convergent display intention, and the content viewing mode of the user corresponding to the convergent display intention is searching for and viewing a specific content; or the display intention type includes a divergent display intention, and the content viewing mode of the user corresponding to the divergent display intention is searching for a class of contents and viewing searched contents one by one.

According to a third aspect of embodiments of the disclosure, an electronic device is provided, including: a processor; and a memory configured to store instructions executable by the processor. The processor is configured to execute the instructions to implement the method as described in the first aspect.

It should be understood that, the above general descriptions and latter detailed descriptions are only illustrative and descriptive, and may not be a limitation of embodiments of the disclosure.

### BRIEF DESCRIPTION OF THE DRAWINGS

In order to explain the embodiments of the disclosure or the technical solution of the disclosure more clearly, the drawings used in the embodiments in the disclosure or the related art will be briefly introduced below. Obviously, the drawings described below are only some embodiments of the disclosure. Those skilled in the art may acquire other drawings from the drawings.

FIG. 1 is a flowchart illustrating a method for displaying search contents in an example embodiment of the disclosure;

FIG. 2 is a diagram illustrating a single-piece display module in an example embodiment of the disclosure;

FIG. 3 is a flowchart illustrating an aggregate display module in an example embodiment of the disclosure;

FIG. 4 is another flowchart illustrating a method for displaying search contents in an example embodiment of the disclosure;

FIG. 5 is another flowchart illustrating a method for displaying search contents in an example embodiment of the disclosure;

FIG. 6 is another flowchart illustrating a method for displaying search contents in an example embodiment of the disclosure;

FIG. 7 is a diagram illustrating an apparatus for displaying search contents in an example embodiment of the disclosure;

FIG. 8 is a diagram illustrating an electronic device in an example embodiment of the disclosure.

### DETAILED DESCRIPTION

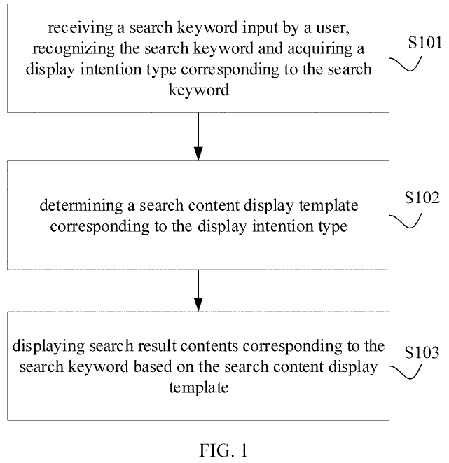

A method for displaying search content and a device in which the method for displaying search content is applied are provided in the disclosure. First, the following is an overall description of the method for displaying search contents. The method for displaying search contents may be implemented by a client, and may be interactively implemented by a client and a server. As illustrated in FIG. 1, it includes the following steps S101 to S103.

At step S101, a search keyword input by a user is received, the search keyword is recognized and a display intention type corresponding to the search keyword is acquired.

Generally, the search keyword is input by the user at the client. When the search keyword is recognized and the display intention type corresponding to the search keyword is acquired, the display intention type corresponding to the search keyword may be recognized and acquired by the client; or, the search keyword also may be uploaded by the client to a server, and the display intention type corresponding to the search keyword may be recognized and acquired by the server.

Specifically, taking a short video content platform as an example, a search interface such as a search box may be configured in a software interface of the client where the short video content platform is located, and the search keyword input by the user through a text or a voice may be received through the search interface.

Different search keywords are applied to different content viewing modes, therefore, different search keywords input by the user correspond to different display intention types. The content viewing mode may be understood as a preferred viewing mode of the user on content in this search. Content viewing of the user may include behaviors such as browsing, click, and frequency on searched content.

Recognizing the search keyword and acquiring the display intention type corresponding to the search keyword may be performed in a variety of manners, including the following two ways:

a) A pre-constructed intention lexicon is acquired, and the display intention type corresponding to the search keyword is looked for in the intention lexicon.

An intention lexicon such as mentioned above may be acquired by performing steps comprising: acquiring historical behavior data of a plurality of different users, the historical behavior data of each of the users including a search keyword input by the user and a content viewing mode of search result contents generated by the user for the search keyword; and determining a display intention type corresponding to the search keyword based on the content viewing mode, and establishing a correspondence relationship between the search keywords and display intention types, to construct the intention lexicon.

The mode of looking for the display intention type corresponding to the search keyword by constructing the intention lexicon is relatively rapid, however, the contained search keywords may be incomplete.

b) A pre-trained intention recognition model is acquired, and the display intention type corresponding to the search keyword is acquired by recognizing the search keyword through the intention recognition model.

An intention recognition model such as mentioned above may be trained by performing steps comprising: acquiring historical behavior data of a plurality of different users, the historical behavior data of each of the users includes a search keyword input by the user and a content viewing mode of search result contents generated by the user for the search keyword; and determining a display intention type corresponding to the search keyword based on the content viewing mode, and training an intention recognition model by taking the search keyword as a training sample and the display intention type corresponding to the search keyword as a label.

The mode of searching for the display intention type corresponding to the search keyword by training the intention mode is relatively complicated, however, various search keywords may be comprehensively and accurately recognized.

In an embodiment of the disclosure, the display intention type corresponding to a search keyword may be acquired by inputting the search keyword into the pre-trained intention recognition model for recognition in response to not finding the display intention type corresponding to the search keyword in an intention lexicon. That is, two intention recognition modes of the intention lexicon and the intention recognition model may be applied in a manner in which both are complementary with each other, which can ensure that the display intention type corresponding to the search keyword is recognized as much as possible.

In embodiments of the disclosure, the display intention type may be roughly divided into a convergent display intention and a divergent display intention. The following are descriptions of the convergent display intention and the divergent display intention.

A) the content viewing intention of the user represented by the convergent display intention is searching for and viewing a specific content, that is, the user searches for a specific content, finds and views the specific content in the search contents, and then this search ends.

For example, the search keyword of the user is “Qi li xiang” (a song name), intention recognition is performed on the search keyword “Qi li xiang” by the pre-trained intention recognition model to determine that the user intention is searching for a specific content (searching for a specific music content “Qi li xiang” for view), that is, the convergent display intention.

b) the content viewing intention of the user represented by the divergent display intention is searching for a class of contents, and viewing searched contents one by one.

For example, the search keyword of the user is “music list”, intention recognition is performed on the search keyword “music list” by the pre-trained intention recognition model to determine that the user intention is searching for a class of contents (searching for a collection of music lists and viewing one by one), that is, the divergent display intention.

For the convergent display intention and the divergent display intention, corresponding content display templates are respectively set, and the content display mode is determined through the content display template. An appropriate content display mode for the search keyword may facilitate content viewing of the user, such as viewing a single specific content, or viewing a plurality of contents one by one, which improves the user experience.

Specifically, intention recognition may be performed on the search keyword by the pre-trained intention recognition model, and training data of the pre-trained intention recognition model may be history search data of respective users in the platform. The history search data may include historical search keyword data of the users, and historical behavior data corresponding to the search keywords.

That is, the search keyword of the user and a content viewing behavior after the user searches for the keyword are acquired in historical data, and the content viewing intention of the user may be acquired based on the content viewing behavior. Training data may be generated in combination with the search keyword. Further, pre-training of the intention recognition model is achieved.

For example, when the user completes searching, there exists a content viewing behavior with a relatively long time (for example, watching a video, entering a user page for viewing) and then exiting the current search, in this case, the search keyword-convergent display intention may be taken as one piece of training data; for another example, when the user completes searching, there exist a plurality of viewing behaviors with a relatively average time, in this case, the search keyword-divergent display intention may be taken as one piece of training data.

At step S102, a search content display template corresponding to the display intention type is determined.

For the convergent display intention and the divergent display intention, corresponding display templates are respectively set. In an embodiment of the disclosure, the convergent display intention may correspond to a single-piece display template, and the divergent display intention may correspond to an aggregate display template.

The single-piece search content display template is determined in response to the display intention type being the convergent display intention, and the single-piece search content display template includes placing a content having a highest correlation with the search keyword in the search contents at a specific location.

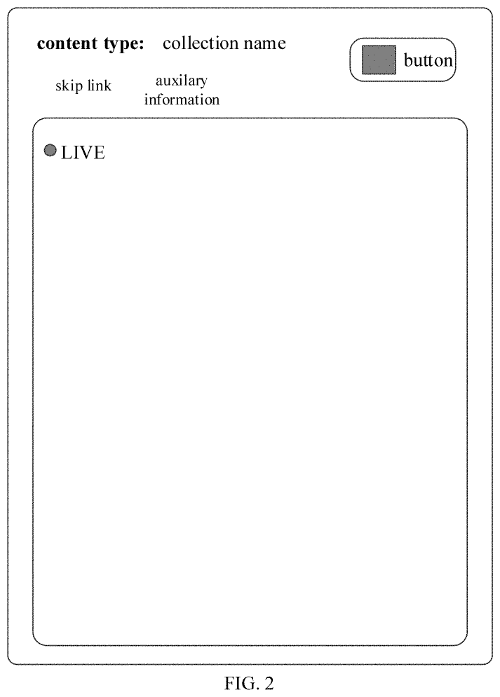

For example, as illustrated in FIG. 2, it is a single-piece display template provided in the embodiment of the disclosure. In the single-piece display template, the content the user is most likely to view is displayed at a location most convenient for the user to view. Generally, the specific location is above a center location of a display page.

The aggregate search content display template is determined in response to the display intention type being the divergent display intention, and the aggregate search content display template includes: placing a content set of a plurality of contents of the search contents, each having a correlation with the search keyword higher than a reference threshold, at a specific location, and shifting the plurality of contents in the content set by horizontal scroll.

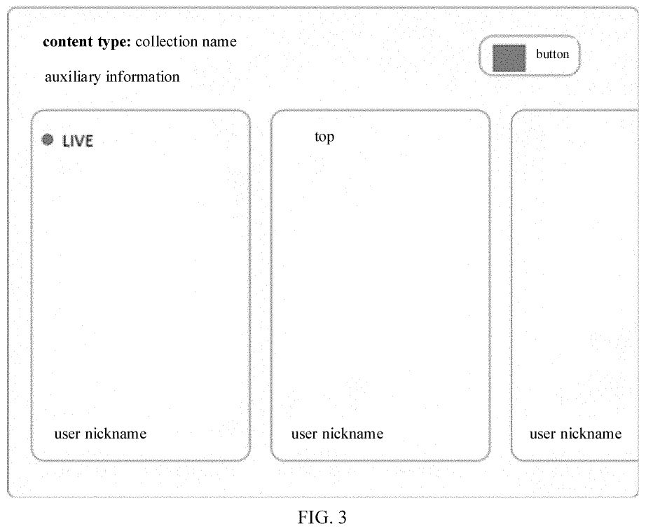

For example, as illustrated in FIG. 3, it is an aggregate display template provided in the embodiment of the disclosure. In the aggregate display template, the content set the user is most likely to view is displayed at a location most convenient for the user to view. Each content in the content set may be scrolled into or out of a display screen by horizontal scroll. Generally, the specific location is above a center location of a display page.

In an embodiment of the disclosure, the single-piece display template or the aggregate display template also may be further divided, for example, the aggregate display template further may be divided into an episode type aggregate display template, a list type aggregate display template, a small theater type aggregate display template.

Specifically, when a set of search contents is obtained based on the search keyword, which specific template is used may be determined based on a content label carried in each search content in the set of search contents.

When most of contents in the set of search contents carry an episode label, the episode type aggregate display template is used, and the contents carrying the episode label are extracted and placed at a specified location of the template in sequence, and respective contents at the specified location may be switched by horizontal scroll.

At step S103, search result contents corresponding to the search keyword are displayed based on the search content display template.

In an embodiment of the disclosure, the client or the server may include a search system, and the search system includes several search databases corresponding to several types, for example, there is a music database corresponding to a music type, and there is a user database corresponding to a user type, and there is an effect database corresponding to an effect type. For one search keyword, a search result may be acquired in each search database, and the search results acquired in each search database may be determined as a set of search contents.

Taking the search keyword “Qi ii xiang” for an example, a song “Qi ii xiang” is obtained by searching the search keyword “Qi ii xiang” in the music database; a user “Jay Chou” (a name) with the highest correlation is obtained by searching the search keyword “Qi ii xiang” in the user database; several videos with high correlation are obtained by searching the search keyword “Qi li xiang” in a short video database. The song “Qi ii xiang”, the user “Jay Chou fan club” and the several videos are determined as search contents corresponding to the search keyword, and added to the set of search contents.

In an embodiment of the disclosure, search contents obtained in a certain search database corresponding to a certain service type may be regarded as search data of the service type. The search data of different service types has respective display rules, for example, a display rule of search data of a music type is to display a music name and a music play button. Display modules are generated based on their respective display rules for searchable data of different service types, and display modules are assembled based on the search content display template corresponding to the display intention type.

A method for displaying search content is provided in embodiments of the disclosure. The display intention type of the user in this search is determined based on the search keyword input by the user, and the search content display template corresponding to the display intention type is determined, and search contents obtained based on the search keyword are displayed based on search content display template. A corresponding search content display template is selected to display the search result by recognizing the content display intention of search contents of the user each time, to achieve accurate display of the search result based on the user intention, and satisfy a personalized display requirement of the user on different search contents.

FIG. 4 is another flowchart illustrating a method for displaying search contents in an example embodiment of the disclosure. The method for displaying search contents may be applied to a server. As illustrated in FIG. 4, it may include the following steps S401 to S403:

At step S401, a search keyword input by a user is acquired, and intention recognition is performed on the search keyword by a pre-trained intention recognition model.

The search keyword may be uploaded by a client to the server, to cause the server to determine the display intention type corresponding to the search keyword based on a pre-trained intention lexicon or a pre-trained intention recognition model.

At step S402, it is determined whether the display intention type represented by the search keyword is recognized. Step S404 is performed if the display intention type represented by the search keyword is recognized, and step S403 is performed if the display intention type represented by the search keyword is not recognized.

At step S403, a historical display intention type of the user is determined as the display intention type of this search.

That is, the display intention type of this search is determined based on the habit display type of the user, if the display intention type corresponding to the search keyword is not recognized.

The habit display type of the user may be pre-analyzed and determined for each user, and also may be currently determined. When the habit display type of a user is determined, the following ways may be adopted but not limited to:

(1-1) a historical content viewing mode of a historical search result content of a user is acquired, and a corresponding plurality of display intention types are determined based on the plurality of historical content viewing modes of the user;

(1-2) the habit display type of the user is determined based on the plurality of display intention types.

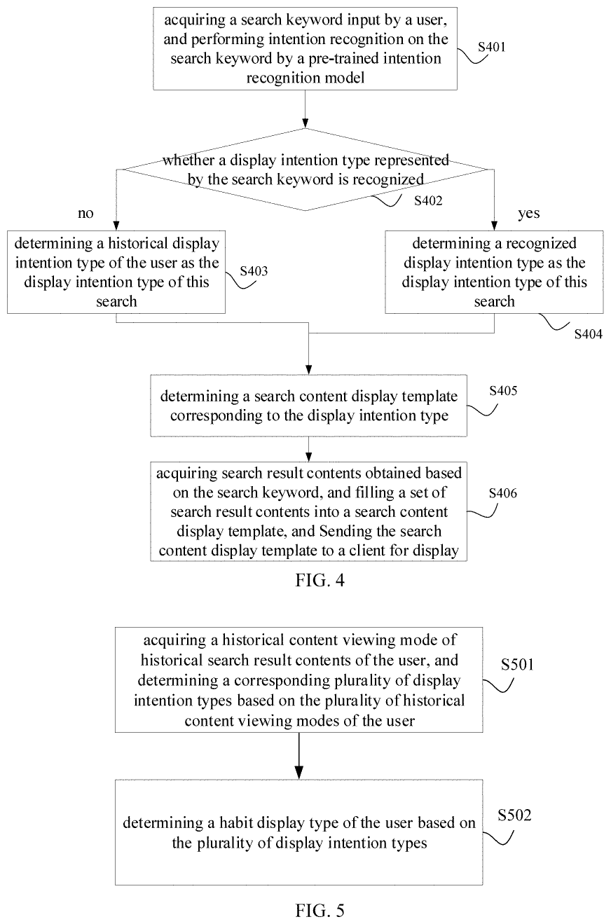

With the specific implementation process of steps (1-1) to (1-2), reference may be made to the embodiments of the disclosure as illustrated in FIG. 5.

It can be seen that, in embodiments of the disclosure, there are two ways for determining the search intention type of this search, that is,

1-1) the search intention type is determined based on the search keyword;

1-2) the search intention type is determined based on the historical habit display type of the user who inputs the search keyword.

The priority of 1-1) is higher than that of 1-2), and 1-2) is taken as a supplementary measure of 1-1). The search intention type may be determined based on the historical habit display type of the user when the search intention type cannot be determined based on the search keyword. The way for determining the search intention type of this search may avoid that the search intention type cannot be determined based on the search keyword due to an obscure search keyword, and since the supplementary measure 1-2) is determined based on the viewing habit of the user, the user experience is good.

At step S404, search result contents obtained based on the search keyword are acquired, and a set of search result contents is filled into the search content display template, and sent to a client for display.

The search keyword may be uploaded by the client to the server, to cause the server to acquire the search result contents corresponding to the search keyword and fill the search result contents into the content display template; and the client may receive and display the content display template filled with the search result contents sent by the server.

It needs to be noted that, the method for displaying search contents provided in the embodiment of the disclosure is described from a perspective of the server, and the server decides a display module and various displayable elements, for example, a color value of a title text of search content, an icon, a pattern, etc. From a perspective of the client, display may be performed only based on received various displayable elements and display styles sent by the server, which achieves less consumption of the client, and avoids picture struck.

FIG. 5 is another flowchart illustrating a method for displaying search contents in an example embodiment of the disclosure. As illustrated in FIG. 5, it may include the following steps S501 to S502.

At step S501, a historical content viewing mode of historical search result contents of the user is acquired, and a corresponding plurality of display intention types are determined based on the plurality of historical content viewing modes of the user. At step S502, the habit display type of the user is determined based on the plurality of display intention types.

In some embodiments, historical data of the user may be acquired, the search keyword of the user and the content viewing behavior after the user searches for the keyword are acquired in historical data, and the display intention type suitable for the viewing behavior may be acquired based on the content viewing behavior. Analysis of the habit display type of the user is achieved in combination with the search keyword.

For example, in the historical data of the user, when the user completes searching, there exists a viewing behavior with a relatively long time (for example, watching a video, entering a user page for viewing), and then exiting the current search, in this case, the search is labeled as a convergent content viewing of the user; for another example, when the user completes searching, there exist a plurality of viewing behaviors with a relatively average time, in this case, the search is labeled as a divergent content viewing intention of the user. Finally, the habit display type of the user is determined as the convergent display type or the divergent display type based on a plurality of labeled historical data, and further the display intention type of this search is determined.

FIG. 6 is another flowchart illustrating a method for displaying search contents in an example embodiment of the disclosure. The method for displaying search contents may be applied to a system consisting of a client and a server. As illustrated in FIG. 6, it may include the following steps S601 to S604.

At step S601, a client receives a search keyword input by a user, and uploads the search keyword to a sever.

At step S602, the server receives the search keyword uploaded by the client, recognizes the search keyword and acquires a display intention type corresponding to the search keyword.

At step S603, the server acquires search result contents corresponding to the search keyword and fills the search result contents into a content display template; and sends the content display template filled with the search result contents to the client.

At step S604, the client displays the search result contents corresponding to the search keyword based on the content display template filled with the search result contents.

A search engine is a common information search tool, and a user may search for required information through a search engine.

Taking a short video content platform as an example, a user inputs a search keyword, and a content platform server determines search contents such as short videos conforming to the search keyword, and sends the search content to a client for display. In the related art, a display style of search contents is usually fixed, and cannot satisfy the personalized requirement of a user for content browsing.

A method for displaying search contents is provided in embodiments of the disclosure. The display intention type of the user in this search is determined based on the search keyword input by the user, and the search content display template corresponding to the display intention type is determined, and search contents obtained based on the search keyword are displayed based on the search content display template. A corresponding search content display template is selected to display the search result by recognizing the content display intention of search contents of the user each time, to achieve accurate display of the search result based on a user intention, and satisfy a personalized display requirement of the user on different search contents.

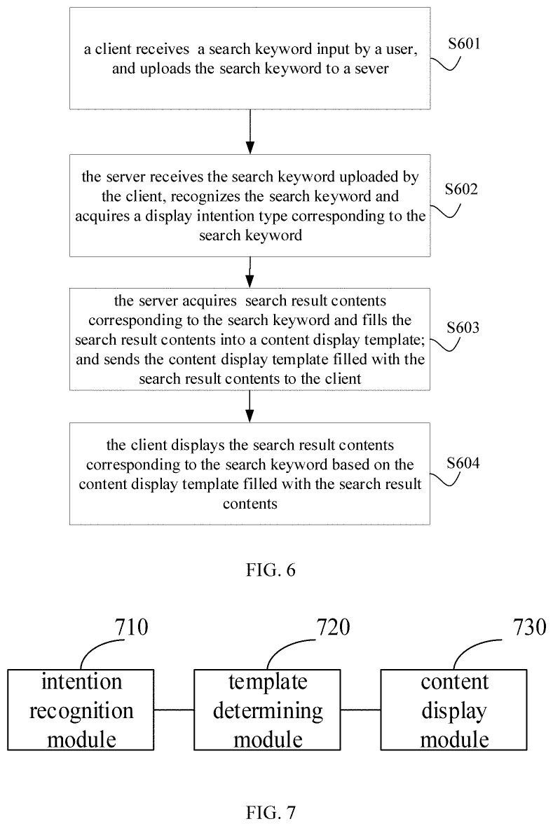

Corresponding to the method embodiments, an apparatus for displaying search contents is further provided in embodiments of the disclosure. As illustrated in FIG. 7, the apparatus for displaying search contents may include an intention recognition module 710, a template determining module 720 and a content display module 730.

The intention recognition module 710 is configured to receive a search keyword input by a user, recognize the search keyword and acquire a display intention type corresponding to the search keyword.

The template determining module 720 is configured to determine a search content display template corresponding to the display intention type.

The content display module 730 is configured to display search result contents corresponding to the search keyword based on the search content display template.

An electronic device is further provided in embodiments of the disclosure. The electronic device includes a memory, a processor and a computer program stored on the memory and capable of running on the processor. The processor performs the method for displaying search contents when executing the program. The method includes: receiving a search keyword input by a user, recognizing and acquiring a display intention type corresponding to the search keyword; determining a search content display template corresponding to the display intention type; and displaying search result contents corresponding to the search keyword based on the search content display template.

In an embodiment of the disclosure, recognizing the search keyword and acquiring the display intention type corresponding to the search keyword, includes: acquiring a pre-constructed intention lexicon, and searching for the display intention type corresponding to the search keyword in the intention lexicon.

In an embodiment of the disclosure, the intention lexicon is constructed by: acquiring historical behavior data of a plurality of different users, the historical behavior data of each of the users including a search keyword input by the user and a content viewing mode of the search result content generated by the user for the search keyword; and determining a display intention type corresponding to the search keyword based on the content viewing mode, and establishing a correspondence relationship between the plurality of groups of search keywords and display intention types, to construct the intention lexicon.

In an embodiment of the disclosure, recognizing the search keyword and acquiring the display intention type corresponding to the search keyword, includes: acquiring a pre-trained intention recognition model, and generating the corresponding display intention type by recognizing the search keyword through the pre-trained intention recognition model.

In an embodiment of the disclosure, a training mode of the intention recognition model includes: acquiring historical behavior data of a plurality of different users, the historical behavior data of each of the users including a search keyword input by the user and a content viewing mode of search result contents generated by the user for the search keyword; determining a display intention type corresponding to the search keyword based on the content viewing mode; and training the intention recognition model by taking the search keyword as a training sample and the display intention type corresponding to the search keyword as a label.

In an embodiment of the disclosure, the processor is further configured to execute instructions to implement: acquiring the display intention type corresponding to the search keyword by inputting the search keyword into the pre-trained intention recognition model for recognition in response to not finding the display intention type corresponding to the search keyword in the intention lexicon.

In an embodiment of the disclosure, the processor is further configured to execute instructions to implement: determining the display intention type based on a habit display type of the user in response to recognizing no display intention type corresponding to the search keyword.

In an embodiment of the disclosure, determining the display intention type based on the habit display type of the user, includes: acquiring a historical content viewing mode of a historical search result content of the user; and determining a corresponding plurality of display intention types based on the plurality of historical content viewing modes of the user and determining the habit display type based on the plurality of display intention types.

In an embodiment of the disclosure, the display intention type includes a convergent display intention, and the user content viewing mode corresponding to the convergent display intention is searching for and viewing a specific content, and determining the search content display template corresponding to the display intention type, includes: determining a single-piece search content display template in response to the display intention type being the convergent display intention, in which the single-piece search content display template includes placing a content having a highest correlation with the search keyword in the search contents at a specific location.

In an embodiment of the disclosure, the display intention type includes a divergent display intention, and the user content viewing mode corresponding to the divergent display intention is searching for a class of contents and viewing searched contents one by one, and determining the search content display template corresponding to the display intention type, includes: determining an aggregate search content display template in response to the display intention type being the divergent display intention, in which the aggregate search content display template includes: placing a content set of a plurality of contents of the search contents, each having a correlation with the search keyword higher than a reference threshold, at a specific location, and shifting the plurality of contents in the content set by horizontal scroll.

In an embodiment of the disclosure, recognizing the search keyword and acquiring the display intention type corresponding to the search keyword, includes: uploading the search keyword to a server, to cause the server to determine the display intention type corresponding to the search keyword based on a pre-trained intention lexicon or a pre-trained intention recognition model.

In an embodiment of the disclosure, displaying the search result contents corresponding to the search keyword based on the search content display template, includes: uploading the search keyword to a server, to cause the server to acquire the search result contents corresponding to the search keyword and fill the search result contents into the content display template; and receiving and displaying the content display template filled with the search result contents sent by the server.

It needs to be noted that, with an implementation process and a technical principle of an electronic device in the embodiment, reference may be made to the foregoing description of the method for displaying search contents in the embodiments, which will not be repeated here.

The electronic device provided in the embodiment of the disclosure may perform the above method for displaying search contents. The display intention type of the user in this search is determined based on the search keyword input by the user, and the search content display template corresponding to the display intention type is determined, and search contents obtained based on the search keyword are displayed based on the search content display template. A corresponding search content display template is selected to display the search result by recognizing the content display intention of search contents of the user each time, to achieve accurate display of the search result based on a user intention, and satisfy a personalized display requirement of the user on different search contents.

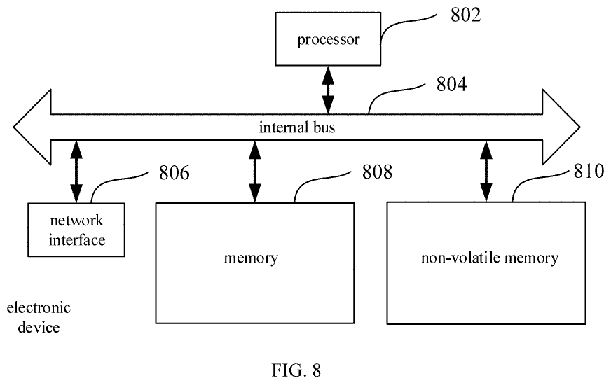

FIG. 8 is a schematic diagram illustrating a structure of an electronic device based on a main device side according to an example embodiment of the disclosure. As illustrated in FIG. 8, at a hardware level, the electronic device includes a processor 802, an internal bus 804, a network interface 806, a memory 804, a non-volatile memory 810, and possibly may include a hardware required by other services. The processor 802 reads a corresponding computer program from a non-volatile memory 801 and runs in a memory 804, and forms an apparatus for performing a method for displaying search content at a logical level. Of course, in addition to a software implementation, other implementations are not excluded in the disclosure, such as a logic device or a combination of hardware and software, that is, the execution body of the following processing flow is not limited to each logical unit, and also may be a hardware or a logic device.

A computer readable storage medium stored with a computer program thereon is further provided in the embodiment of the disclosure. The program implements the method for displaying search contents when performed by a processor. The method includes: receiving a search keyword input by a user, recognizing the search keyword and acquiring a display intention type corresponding to the search keyword; determining a search content display template corresponding to the display intention type; and displaying search result contents corresponding to the search keyword based on the search content display template.

Computer-readable media include permanent and non-permanent, removable and non-removable media that may be stored by any method or technology. Information may be a computer-readable instruction, a data structure, a program module, or other data. Examples of storage media of a computer include but are not limited to a phase change memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technology, a compact disc read-only memory (CD-ROM), a digital video disk (DVD) or other optical storages, magnetic cassettes, magnetic tape magnetic storage device storage or other magnetic storage devices or any other non-transmission medium that may be used to store information that may be accessed by a computing device. As defined in the disclosure, a computer-readable media do not include transitory media such as a modulated data signal and a carrier.

Since the apparatus embodiments basically correspond to the method embodiments, please refer to part of descriptions of the method embodiments for relevant information. The above apparatus embodiments are merely schematic, the units described as separate components may or may not be physically separated, and components displayed as units may or may not be physical units, that is, may be located in one place, or may be distributed on a plurality of network units. Some or all of the modules may be selected according to actual requirements to achieve the solutions in the embodiments. Those skilled in the art may understand and implement the method without any creative effort.

The system, apparatus, module or unit elaborated in the embodiment may be achieved by a computer chip or an entity, or achieved by a product with a certain function. A typical implementation device is a computer, and the specific form of the computer may be a personal computer, a laptop, a cellular phone, a camera phone, a smart phone, a personal digital assistant, a media player, a navigation device, an E-mail transceiver, a game console, a tablet, a wearable device, or any combination of these devices.

The foregoing only are implementations of the embodiments of the disclosure. It should be noted that, for those skilled in the art, several improvements and modifications may be made without departing from the principles of the embodiments of the disclosure, and improvements and modifications are also considered to be within the protection scope of the embodiments of the disclosure.

1. A method for displaying search contents, comprising:
receiving a search keyword input by a user, recognizing and acquiring a display intention type corresponding to the search keyword, wherein the display intention type is corresponding to a content viewing mode of the user a search result, and the content viewing mode is a preferred viewing mode of the user on the search result in a current search, wherein the display intention type comprises a convergent display intention, and the content viewing mode of the user corresponding to the convergent display intention is searching for and viewing a specific content; or the display intention type comprises a divergent display intention, and the content viewing mode of the user corresponding to the divergent display intention is searching for a class of contents and viewing searched contents one by one;
determining a search content display template corresponding to the display intention type; and
displaying search result contents corresponding to the search keyword based on the search content display template.

2. The method of claim 1, wherein recognizing and acquiring the display intention type corresponding to the search keyword at least comprises:
acquiring a pre-constructed intention lexicon, and searching for the display intention type corresponding to the search keyword in the intention lexicon.

3. The method of claim 2, wherein the intention lexicon is constructed by:
acquiring historical behavior data of a plurality of different users, wherein the historical behavior data of each of the users comprises a search keyword input by the user and a content viewing mode of search result contents generated by the user for the search keyword; and
determining a display intention type corresponding to the search keyword based on the content viewing mode, and establishing a correspondence relationship between a plurality of groups of search keywords and display intention types, to construct the intention lexicon.

4. The method of claim 1, wherein recognizing and acquiring the display intention type corresponding to the search keyword at least comprises:
acquiring a pre-trained intention recognition model; and
generating a corresponding display intention type by recognizing the search keyword through the pre-trained intention recognition model.

5. The method of claim 4, wherein a training mode of the intention recognition model comprises:
acquiring historical behavior data of a plurality of different users, wherein, the historical behavior data of each of the users comprises a search keyword input by the user and a content viewing mode of search result contents generated by the user for the search keyword;
determining a display intention type corresponding to the search keyword based on the content viewing mode; and
training the intention recognition model by taking the search keyword as a training sample and the display intention type corresponding to the search keyword as a label.

6. The method of claim 2, further comprising:
acquiring the display intention type corresponding to the search keyword by inputting the search keyword into the pre-trained intention recognition model for recognition in response to not finding the display intention type corresponding to the search keyword in the intention lexicon.

7. The method of claim 1, further comprising:
determining the display intention type based on a habit display type of the user in response to recognizing no display intention type corresponding to the search keyword.

8. The method of claim 7, wherein determining the display intention type based on the habit display type of the user, comprises:
acquiring a plurality of historical content viewing mode of historical search result contents of the user; and
determining a plurality of display intention types based on the plurality of historical content viewing modes of the user and determining the habit display type of the user based on the plurality of display intention types.

9. The method of claim 1, wherein, determining the search content display template corresponding to the display intention type comprises:
determining a single-piece search content display template in response to the display intention type being the convergent display intention, wherein, the single-piece search content display template comprises placing a content having a highest correlation with the search keyword in the search contents at a specific location.

10. The method of claim 1, wherein, determining the search content display template corresponding to the display intention type, comprises:
determining an aggregate search content display template in response to the display intention type being the divergent display intention, wherein, the aggregate search content display template comprises placing a content set of a plurality of contents of the search contents, each having a correlation with the search keyword higher than a reference threshold, at a specific location, and shifting the plurality of contents in the content set by horizontal scroll.

11. The method of any of claims 1-5, wherein recognizing and acquiring the display intention type corresponding to the search keyword, comprises:
uploading the search keyword to a server, to cause the server to determine the display intention type corresponding to the search keyword based on a pre-constructed intention lexicon or a pre-trained intention recognition model.

12. The method of claim 1, wherein displaying the search result contents corresponding to the search keyword based on the search content display template, comprises:
uploading the search keyword to a server, to cause the server to acquire the search result contents corresponding to the search keyword and fill the search result contents into the content display template; and
receiving and displaying the content display template filled with the search result contents sent by the server.

13. An apparatus for displaying search contents, comprising:
an intention recognition module, configured to receive a search keyword input by a user, recognize the search keyword and acquire a display intention type corresponding to the search keyword, wherein the display intention type is corresponding to a content viewing mode of the user a search result, and the content viewing mode is a preferred viewing mode of the user on the search result in a current search, wherein the display intention type comprises a convergent display intention, and the content viewing mode of the user corresponding to the convergent display intention is searching for and viewing a specific content; or the display intention type comprises a divergent display intention, and the content viewing mode of the user corresponding to the divergent display intention is searching for a class of contents and viewing searched contents one by one;
a template determining module, configured to determine a search content display template corresponding to the display intention type; and
a content display module, configured to display search result contents corresponding to the search keyword based on the search content display template.

14. The apparatus of claim 13, wherein, the intention recognition module is configured to:
acquire a pre-constructed intention lexicon, and search for the display intention type corresponding to the search keyword in the intention lexicon.

15. The apparatus of claim 14, wherein, the intention recognition module is configured to:
acquire historical behavior data of a plurality of different users, wherein, the historical behavior data of each of the users comprises a search keyword input by the user and a content viewing mode of search result contents generated by the user for the search keyword; and
determine a display intention type corresponding to the search keyword based on the content viewing mode, and establish a correspondence relationship between the plurality of groups of search keywords and display intention types, to construct the intention lexicon.

16. The apparatus of claim 13, wherein, the intention recognition module is configured to:
acquire a pre-trained intention recognition model; and
generate a corresponding display intention type by recognizing the search keyword through the pre-trained intention recognition model.

17. The apparatus of claim 16, wherein, the intention recognition module is configured to:
acquire historical behavior data of a plurality of different users, wherein, the historical behavior data of each of the users comprises a search keyword input by the user and a content viewing mode of search result contents generated by the user for the search keyword; and
determine a display intention type corresponding to the search keyword based on the content viewing mode, and train the intention recognition model by taking the search keyword as a training sample and the display intention type corresponding to the search keyword as a label.

18. The apparatus of claim 14, further comprising:
a recognition selection module, configured to acquire the display intention type corresponding to the search keyword by inputting the search keyword into the pre-trained intention recognition model for recognition in response to not finding the display intention type corresponding to the search keyword in the intention lexicon.

19. The apparatus of claim 13, further comprising:
a user recognition module, configured to determine the display intention type based on a habit display type of the user in response to recognizing no display intention type corresponding to the search keyword.

20. The apparatus of claim 19, wherein, the user recognition module is configured to:
acquire a plurality of historical content viewing modes of historical search result contents of the user; and
determine a plurality of display intention types based on the plurality of historical content viewing modes of the user and determine the habit display type of the user based on the plurality of display intention types.

21. The apparatus of claim 13, wherein the content display module is configured to:
determine a single-piece search content display template in response to the display intention type being the convergent display intention, wherein, the single-piece search content display template comprises placing a content having a highest correlation with the search keyword in the search contents at a specific location.

22. The apparatus of claim 13, wherein the content display module is configured to:
determine an aggregate search content display template in response to the display intention type being the divergent display intention, wherein, the aggregate search content display template comprises placing a content set of a plurality of contents of the search contents, each having a correlation with the search keyword higher than a reference threshold, at a specific location, and shifting the plurality of contents in the content set by horizontal scroll.

23. The apparatus of any of claims 13 to 17, wherein, the intention recognition module is configured to:
upload the search keyword to a server, to cause the server to determine the display intention type corresponding to the search keyword based on a pre-constructed intention lexicon or a pre-trained intention recognition model.

24. The apparatus of claim 13, wherein, the content display module is configured to:
upload the search keyword to a server, to cause the server to acquire search result contents corresponding to the search keyword and fill the search result contents into the content display template; and
receive and display the content display template filled with the search result contents sent by the server.

25. A server for displaying search contents, comprising a processor and a memory configured to store instructions executable by the processor, wherein, the processor is configured to execute the instructions to implement:
receiving a search keyword uploaded by a client, recognizing and acquiring a display intention type corresponding to the search keyword, wherein the display intention type is corresponding to a content viewing mode of the user a search result, and the content viewing mode is a preferred viewing mode of the user on the search result in a current search, wherein the display intention type comprises a convergent display intention, and the content viewing mode of the user corresponding to the convergent display intention is searching for and viewing a specific content; or the display intention type comprises a divergent display intention, and the content viewing mode of the user corresponding to the divergent display intention is searching for a class of contents and viewing searched contents one by one;
acquiring search result contents corresponding to the search keyword and filling the search result contents into the content display template; and
sending the content display template filled with the search result contents to the client for display.

26. A terminal, comprising a processor and a memory configured to store instructions executable by the processor, wherein, the processor is configured to execute the instructions to implement the method according to any of claims 1-12.

27. A system for displaying search contents, comprising the server of claim 25 and the terminal of claim 26.

28. A storage medium, wherein when instructions in the storage medium are executed by a processor of an electronic device, the electronic device is caused to perform the method of any of claims 1 to 12.
